(19) United States
(12) Patent Application Publication
(10) Pub. No.: US 2006/0257813 A1
(43) Pub. Date: Nov. 16, 2006

(54) Orthodontic spring

(76) Inventor: Kenneth J. Highland, San Jose, CA (US)

Correspondence Address: Kenneth J. Highland, 773 Sunset Glen Dr., San Jose, CA, 95123, US

(21) Appl. No.: 11/435,493

(22) Filed: May 16, 2006

Related U.S. Application Data
(60) Provisional application No. 60/681,419, filed on May 16, 2005.

(51) Int. Cl. A61C 3/00

(52) U.S. Cl. 433/21

(57) ABSTRACT

An orthodontic spring is disclosed. A first portion is disposed at an obtuse angle relative to a second portion about a bend line. A plurality of loops of either the first or second portion are engageable to brackets of an orthodontic appliance to provide a force to the brackets. Helical ends of the orthodontic spring provide a means for attaching the orthodontic spring to orthodontic appliances.

### CROSS REFERENCE TO RELATED APPLICATIONS

The present application claims priority under 35 U.S.C. 119(e) from provisional patent application Ser. No. 60/681,419, entitled “Orthodontic Spring”, filed on May 16, 2005, the disclosure of which is herein incorporated by reference in its entirety.

### BACKGROUND OF THE INVENTION

The present invention generally relates to orthodontic appliances and more particularly to an orthodontic spring.

The present invention is related to patent application Ser. No. 11/212,151 entitled “Orthodontic Closing Spring” filed on Aug. 26, 2005, the disclosure of which is incorporated in its entirety herein. The disclosed orthodontic closing spring provides a closing force to the sides of multiple orthodontic appliances using a plurality of loops such that the loops are spaced to be effective at common inter bracket distances. The orthodontic spring can be applied to common bracket dimensions and expresses forces directly to the brackets.

It has been found that the disclosed orthodontic closing spring suffers the disadvantage of in some cases adversely impacting the gingiva or gums of the user. A portion of the orthodontic closing spring may contact and irritate the gums of user leading to bleeding and other complications.

There is therefore a need in the art for an orthodontic spring that does not impact the gingiva of the user. There is also a need for an orthodontic spring having a first portion engageable to orthodontic appliance brackets and a second portion disposed at an angle relative to the second portion for distanced engagement from a users gums.

### SUMMARY OF THE INVENTION

The present invention overcomes the limitations of the prior art by providing an improved orthodontic spring having a first portion disposed at an angle relative to a second portion. The angle is preferably obtuse.

In accordance with one embodiment of the invention, an orthodontic spring includes a spring having a first portion and a second portion disposed about a bend line, the bend line defining an angle therebetween.

In accordance with another embodiment of the invention, an orthodontic spring for exerting a force upon an orthodontic appliance includes a plurality of loops terminating at each end in a helical end portion, the plurality of loops comprising a first spring portion and a second spring portion.

In accordance with yet another embodiment of the invention, an orthodontic spring having a plurality of loops engageable with brackets of an orthodontic appliance includes a first spring portion, and a second spring portion, the first and second spring portions being defined by a bend line therebetween.

These and other features, aspects and advantages of the present invention will become better understood with reference to the following drawings, description and claims.

### BRIEF DESCRIPTION OF THE DRAWINGS

FIG. 1 is plan view of an orthodontic spring in accordance with the invention;

FIG. 2 is a cross sectional view of the orthodontic spring in accordance with the invention; and

FIG. 3 is a plan view of representative helical ends of the orthodontic spring in accordance with the invention.

### DETAILED DESCRIPTION OF THE INVENTION

The following detailed description is of the best modes of carrying out the invention. The description is not to be taken in a limiting sense, but is made merely for the purpose of illustrating the general principles of the invention, since the scope of the invention is best defined by the appended claims.

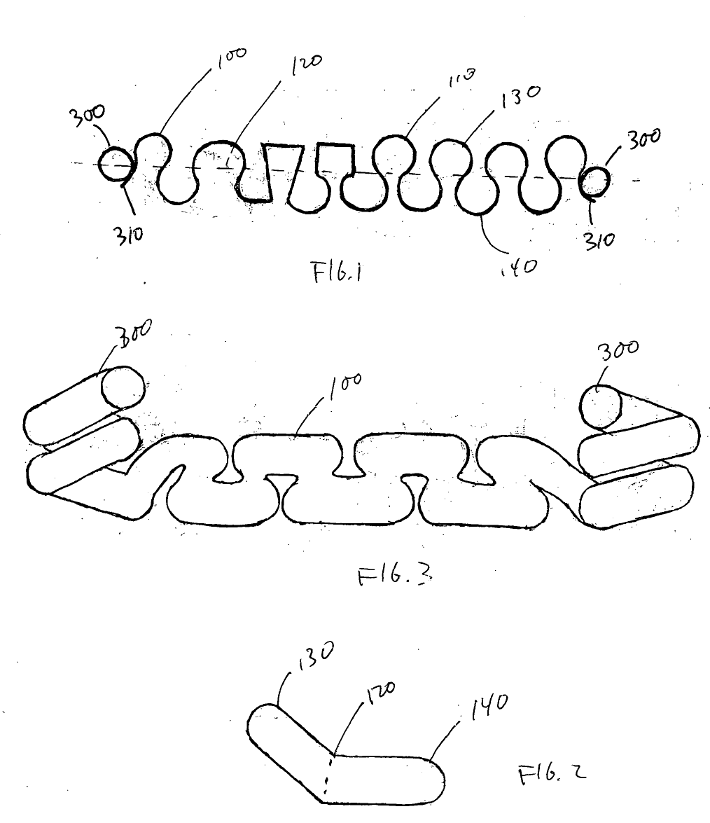

The present invention generally provides an orthodontic spring having a first portion disposed at an obtuse angle relative to a second portion. With reference to FIG. 1, an orthodontic spring 100 may include a plurality of loops 110 which may be of various configurations including round, oval, rectangular, triangular or any morphed combination of these shapes. The spacing between the loops 110 may be such that the orthodontic spring 100 may be extended to be engaged to brackets (not shown) of an orthodontic appliance (not shown). Loops 110 may be spaced at varied dimensions to accommodate the brackets.

A bend line 120 may be formed at a desirable location along the length of the orthodontic spring 100. The bend line 120 may partition the orthodontic spring 100 into a first portion 130 and a second portion 140. As shown in FIG. 2, first portion 130 may be disposed at an obtuse angle relative to second portion 140 about bend line 120. Those skilled in the art will appreciate that either first portion 130 or second portion 140 may be advantageously engaged with the brackets of the orthodontic appliance with a corresponding unengaged first or second portion 130, 140 angled away from a user's gums.

With reference to FIG. 1 and FIG. 3, helical ends 300 of orthodontic spring 100 may provide a means for attaching the orthodontic spring to the orthodontic appliance. Helical ends 300 each further comprise a tail 310 extending a distance away from the helical coil. Each tail 310 may facilitate the attachment of the helical ends 300 of the closing spring 100 to orthodontic appliances.

In a first exemplary use of the closing spring 100, to attach the helical end 300 to a lingual button (not shown), the tail 310 may be used in cooperation with a common dental instrument such as a probe, a scaler, a pliers and a hemostat, to open the helical end 300 to thereby extend a diameter of the helical end 300. The extended diameter helical end 300 of the closing spring 100 may then be slipped over the lingual button to secure the closing spring 100 to the lingual button.

In a second exemplary use of the closing spring 100, the helical end 300 of the closing spring 100 may be attached to a chain secured to an impacted tooth. The tail 310 may advantageously be used to thread the helical end 300 through a loop of the chain to thereby facilitate the attachment of the closing spring 100 to the chain.

The present invention advantageously provides an orthodontic spring having first and second portions disposed at an obtuse angle one from the other. In use, the orthodontic spring provides for a portion which does not contact a user's gums and thereby provides relief from contact with the user's gums to prevent bleeding and other complications.

It should be understood, of course, that the foregoing relates to preferred embodiments of the invention and that modifications may be made without departing from the spirit and scope of the invention as set forth in the following claims.

We claim:

1. An orthodontic spring comprising:
a spring having a first portion and a second portion disposed about a bend line, the bend line defining an angle therebetween.

2. The orthodontic spring of claim 1, wherein the angle is obtuse.

3. The orthodontic spring of claim 1, wherein the spring comprises a plurality of loops.

4. The orthodontic spring of claim 3, wherein the loops are round.

5. The orthodontic spring of claim 3, wherein the loops are oval.

6. The orthodontic spring of claim 3, wherein the loops are rectangular.

7. The orthodontic spring of claim 3, wherein the loops are triangular.

8. The orthodontic spring of claim 3, wherein the loops are of irregular shape.

9. The orthodontic spring of claim 1, further comprising a pair of helical end portions.

10. The orthodontic spring of claim 9, wherein each helical end portion comprises a tail.

11. An orthodontic spring for exerting a force upon an orthodontic appliance comprising:
a plurality of loops terminating at each end in a helical end portion, the plurality of loops comprising a first spring portion and a second spring portion.

12. The orthodontic spring of claim 11, further comprising a tail formed at ends of each helical end portion.

13. The orthodontic spring of claim 11, wherein the helical end portions are sized and configured to engage a lingual button.

14. The orthodontic spring of claim 11, further comprising a bend line formed along a length of the orthodontic spring, the bend line defining an angle between the first and second spring portions.

15. The orthodontic spring of claim 14, wherein the angle is obtuse.

16. An orthodontic spring having a plurality of loops engageable with brackets of an orthodontic appliance comprising:
a first spring portion; and
a second spring portion, the first and second spring portions being defined by a bend line therebetween.

17. The orthodontic spring of claim 16, wherein the bend line defines an obtuse angle between the first and second spring portions.

18. The orthodontic spring of claim 16, further comprising helical ends formed at ends of the spring, the helical ends comprising a terminating tail.

19. The orthodontic spring of claim 18, wherein each helical end has a relaxed dimension and an expanded dimension, the expanded dimension providing clearance for attachment of the helical end to an orthodontic appliance.

20. The orthodontic spring of claim 18, wherein the terminating tail facilitates expansion of the helical end.
